(19) United States
(12) Patent Application Publication
(10) Pub. No.: US 2009/0319740 A1
(43) Pub. Date: Dec. 24, 2009

(54) VIRTUAL COMPUTER SYSTEM, INFORMATION PROCESSING DEVICE PROVIDING VIRTUAL COMPUTER SYSTEM, AND PROGRAM THEREOF

(75) Inventor: Hidetoshi Nishi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/389,544

(22) Filed: Feb. 20, 2009

(30) Foreign Application Priority Data
Jun. 18, 2008 (JP) 2008-158906

(51) Int. Cl. G06F 9/455; G06F 12/14

(52) U.S. Cl. 711/163; 718/1; 711/E12.091

(57) ABSTRACT

A virtual computer system where a plurality of guest domains run on one information processing device. The virtual computer system includes a system region for storing software, which is installed for the plurality of guest domains, to be managed by the virtual computer system in a shared manner and an update region for actually storing data when each of the plurality of guest domains makes a write access to the system region.

### CROSS-REFERENCE TO RELATED APPLICATION

This application is based upon and claims the benefit of priority of the prior Japanese Patent Application No. 2008-158906, filed on 18 Jun. 2008, the entire contents of which are incorporated herein by reference.

### FIELD

The embodiments discussed herein are related to a virtual computer system.

### BACKGROUND

A virtual computer technology for implementing the hardware resources of a computer with software in a pseudo manner and for virtually providing a computer environment in a computer system is widely known (Patent Documents 1, 2 and 3).

A configuration example of a virtual computer system is depicted in FIG. 1.

The system includes a server 201 and a management terminal 214.

The server 201 is configured with an information processing device composed of a processor (CPU), a memory, storage resources for storing a program, etc., and an I/O interface. The server 201 is connected to the management terminal 214 via an NIC (Network Interface Card) 217, and a communications line of a LAN (Local Area Network), or the like.

On the server 201, a virtual computer, which is a logical computer separated from the physical computer, operates. In this specification, the execution unit of the virtual computer is referred to as a “domain”.

On the server 201, a plurality of guest domains 203 can simultaneously run. An OS used by each of the guest domains 203 is referred to as a guest OS. The guest OS may vary depending on each guest domain 203.

Additionally, one management domain 202 exists on the server 201. The management domain 202 has a guest domain config file 209 that is a file for defining the configuration of each guest domain 203, and manages a virtual computer environment.

Hypervisor 213 is a virtual machine monitor for controlling all of functions of the virtual machine.

Each of the guest domains 203 uses a system disk 205 the required capacity of which is secured. The system disk 205 is secured for each of the guest domains 203, and stores each guest OS, settings, patch, etc. The system disk 205 is a virtual disk of each of the guest domains 203, and actually provided by being partitioned on the disk 206.

Each of the guest domains 203 makes an access to its system disk 205 as follows. Initially, a driver within each of the guest domains 203 makes an access to the system disk 205. Then, an FE driver (Front End Driver) 212 within the guest domain 203 and a BE driver (Back End Driver) 211 within the management domain 202 pair up to control an I/O access made from the guest domain 203. Then, the I/O access of the FE driver 212 and the BE driver 211 is conveyed to a real driver 210 in the management domain 202, and implemented as an access to the disk 206 that is an I/O device of the server 201. Each of the guest domains 203 makes an access to the system disk 205 in this way. Actually, however, this access operates as an access to the region of the disk 206, in which the system disk 206 is stored.

A user sets a guest domain by changing the settings, etc. of the guest domain config file 209 of the management domain 202 with the management terminal 214. Additionally, the user issues instructions such as activation/suspension of a guest domain 203 to the management domain 202. Each of the guest domains 203, the management domain 202, and the NIC 217 are connected by a virtual network 218 within the server 201.

The case of setting a new guest domain in the virtual computer system configured as depicted in FIG. 1 is described in further detail with reference to FIG. 2.

Initially, a user logs in to the management domain 202 with the management terminal 214, and defines a new guest domain by updating the guest domain config file 209 (an arrow A of FIG. 2). At this time, a disk the capacity of which is required by the newly added guest domain is extracted from the disk 206 recognized by the management domain 202 (an arrow B of FIG. 2), and the extracted disk is defined as a system disk 205 and a work disk 220 of the new guest domain 203 in the guest domain config file 209. As a result, the guest domain 203 can recognize the system disk 205 and the work disk 220. Then, the user logs in to the management domain 202 with the management terminal 214, and installs an OS, for example, from a CD-ROM, which is inserted in a storage medium driving device 219 of the server 201, on the newly defined system disk 205 (an arrow C of FIG. 2). In this way, the OS is stored in the system disk region of the disk 206.

In the case of setting a plurality of guest domains, the process of FIG. 2 is similarly executed to make the settings of the plurality of guest domains.

Next, the case of activating (starting up) a guest domain is described in further detail with reference to FIG. 3.

In the case of activating a guest domain, a user initially logs in to the management domain 202 with the management terminal 214, and instructs the management domain 202 to activate the guest domain 203 in accordance with the guest domain config file 209 (an arrow D of FIG. 3). The guest domain 203 makes an access to the system disk 205 defined in the guest domain config file 209. The access made from the guest domain 203 to the system disk 205 is implemented as an access to a system disk region of the real disk 206 by the FE driver 212 of the guest domain 203, the BE driver 211 of the management domain 202, and the real driver 210 as described above. Then, an OS is read from the corresponding portion of the disk 206 (an arrow E of FIG. 3).

The case of applying a patch to a guest OS is described in further detail with reference to FIG. 4.

A user makes an access to a guest domain 203 with the management terminal 214, and transmits a patch to the guest domain 203 (an arrow F of FIG. 4). Then, the user instructs the guest domain 203 to apply the patch to the guest OS. The guest domain 203 makes a write access to the system disk 205. This access is implemented as an access to the system disk region of the disk 206 by the FE driver 212, the BE driver 211, and the real driver 210 as described above. With this write access, the patch is stored on the disk 206 (an arrow G of FIG. 4).

The conventional virtual computer system has been described with reference to FIGS. 2 to 4.

With the conventional virtual computer system, a user must perform operations in each guest domain in the case of newly setting a guest domain, in the case of activating a guest domain, and in the case of applying a patch to a guest OS as described above. Namely, even if one guest domain uses the same OS that is used by another guest domain, the OS must be installed on the disk allocated to the new guest domain. For example, even if guest domains a and b of FIG. 1 use the same OS, it must be installed on both of system disks 205a and 205b respectively. This causes an operating efficiency problem that the user must repeat similar installation operations, and a disk resources problem that the same OS is redundantly installed on the disk 106 of the server.

Additionally, with the operations such as an operation for applying a patch to a guest OS, target guest domains must be individually activated and the patch must be respectively applied to the guest domains. This also causes a problem of decreasing an operating efficiency.

[Patent Document 1] Japanese Laid-Open Patent Publication No. 2007-066265

[Patent Document 2] Japanese Laid-Open Patent Publication No. 7-105091

[Patent Document 3] Japanese Laid-Open Patent Publication No. 7-093221

### SUMMARY

According to an aspect of the embodiment, a virtual computer system where a plurality of guest domains run on one information processing device, includes, a system region for storing software, which is installed for the plurality of guest domains, to be managed by the virtual computer system in a shared manner; and an update region for actually storing data when each of the plurality of guest domains makes a write access to the system region.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a schematic diagram depicting a configuration of a conventional virtual computer system;

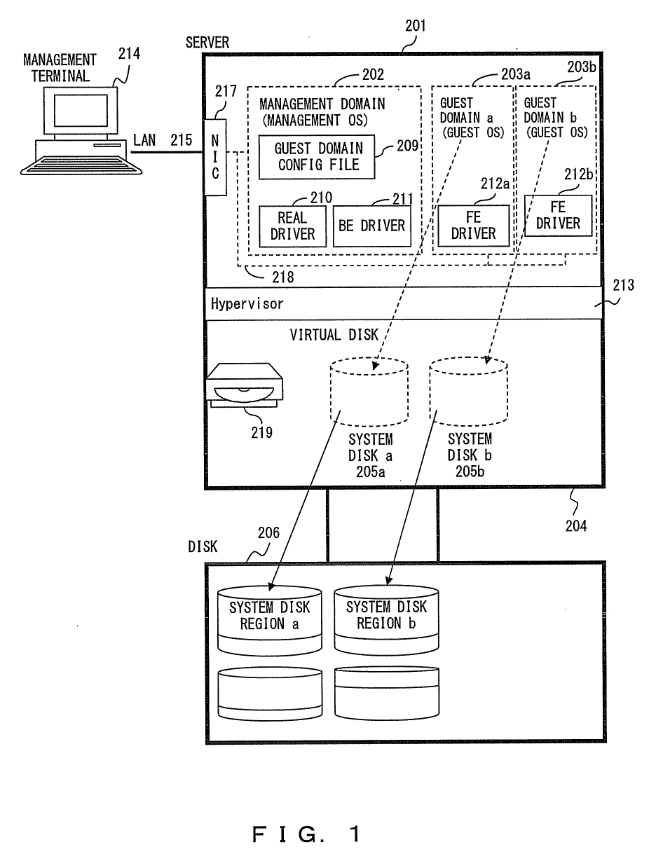

FIG. 2 is a schematic diagram for explaining the case of setting a guest domain in the conventional system;

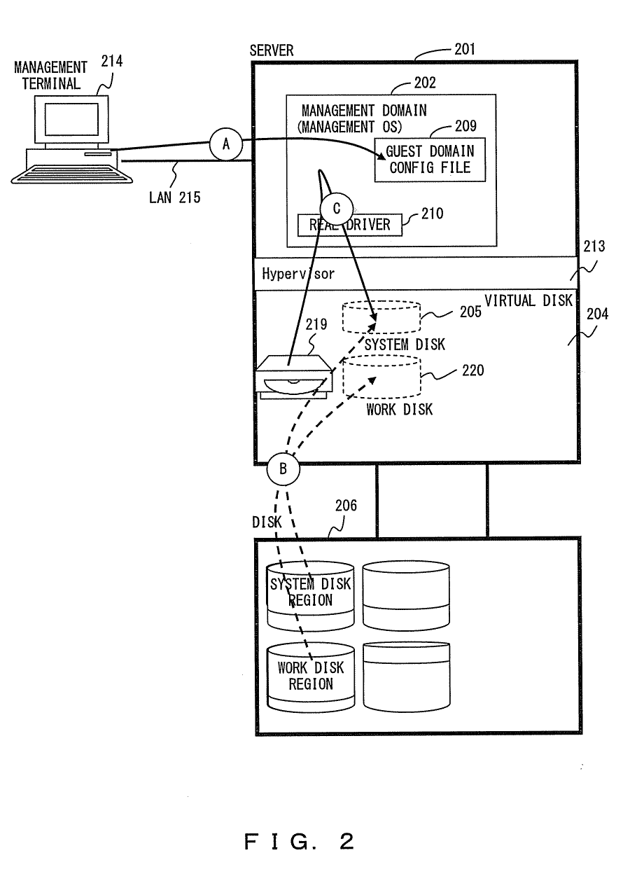

FIG. 3 is a schematic diagram for explaining the case of activating a guest domain in the conventional system;

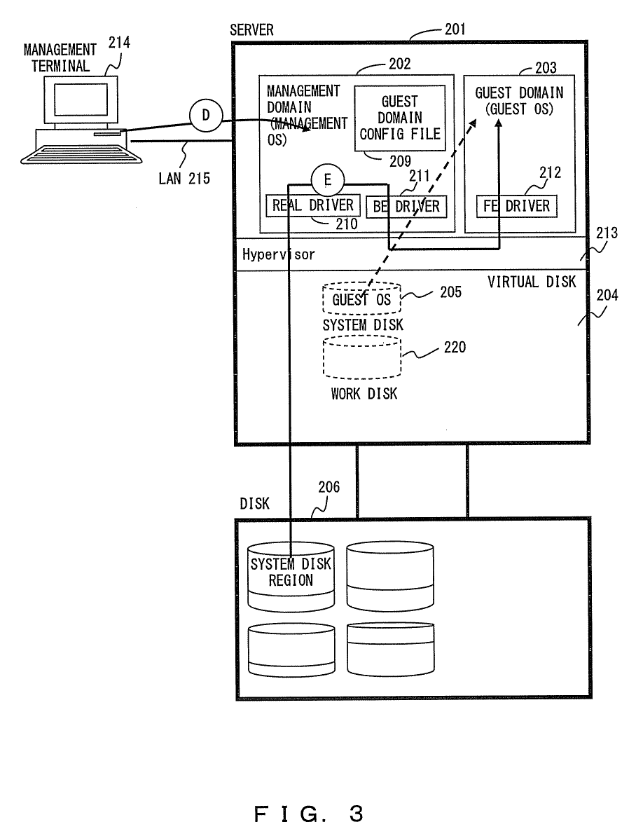

FIG. 4 is a schematic diagram for explaining the case of applying a patch to an OS in the conventional system;

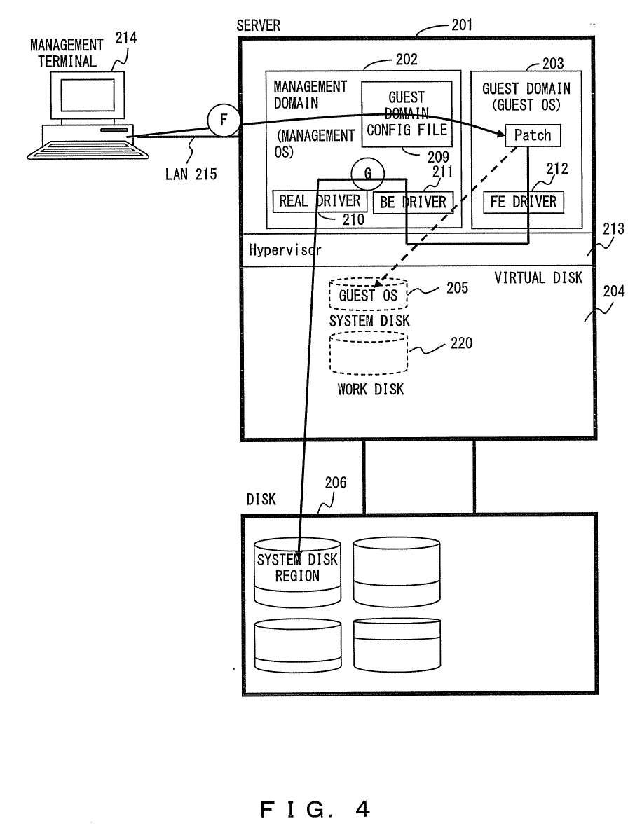

FIG. 5 is a schematic diagram depicting a configuration of an embodiment according to the present invention;

FIG. 6 is a schematic diagram depicting a configuration of a first embodiment;

FIG. 7 is a schematic diagram depicting a structure of Table 1;

FIG. 8 is a schematic diagram depicting a structure of Table 2;

FIG. 9 is a schematic diagram depicting a structure of Table 3;

FIG. 10 is a flowchart of a management domain in the case of newly adding a guest domain in the first embodiment;

FIG. 11 is a flowchart of the management domain/BE driver in the case of activating a guest domain in the first embodiment;

FIG. 12 is a flowchart of the management domain/BE driver in the case where a write access is made from a guest domain in the first embodiment;

FIG. 13 is a schematic diagram depicting a configuration of a second embodiment;

FIG. 14 is a schematic diagram depicting a structure of Table 4;

FIG. 15 is a flowchart of a management domain/BE driver in the case of activating a guest domain in the second embodiment;

FIG. 16 is a schematic diagram depicting a configuration of a third embodiment;

FIG. 17 is a schematic diagram depicting a structure of Table 5;

FIG. 18 is a flowchart of a management domain/BE driver in the case of merging data with a system region in the third embodiment;

FIG. 19 is a schematic diagram depicting a configuration of a fourth embodiment;

FIG. 20 is a schematic diagram depicting a structure of Table 6;

FIG. 21 is a block diagram depicting a configuration of an information processing device; and

FIG. 22 is a schematic diagram for explaining the loading of a program into the information processing device.

### DESCRIPTION OF EMBODIMENTS

The demand for saving disk resources to be used and for an increase in the efficiency of setting operations has been increasing in a virtual computer system.

Therefore, embodiments of the invention save disk resources used by a virtual computer system, and increase the efficiency of setting operations of guest domains in the virtual computer system.

According to an aspect of an embodiment of the invention, software installed for guest domains is stored in a system region of disk resources of the virtual computer system, and managed in a shared manner. When a write access is made from each guest domain to the system region, whether or not the write is permitted is determined. If the write is prohibited, data is stored in an update region for storing data of each guest domain.

In the above described configuration, when the guest domain reads data of the system region, the data of the system region and the update region of each guest domain are merged and passed to the guest domain, whereby corresponding data can be passed to each guest domain. Such a configuration enables the disk resources to be saved because software is managed in a shared manner. Additionally, when a plurality of guest domains use the same software, there is no need to install the software and to apply a patch to the software respectively for the guest domains. As a result, the operating efficiency of a user can be increased.

With the disclosed virtual computer system, disk resources used by the system can be more efficiently used, and the efficiency of setting operations of guest domains can be increased.

Embodiments of the present invention are explained with reference to accompanying drawings.

The embodiments described below explain that an operating system is managed by a virtual computer system in a shared manner as software installed for guest domains. However, the present invention is not limited to this configuration. Namely, the present invention can be implemented by using application software or data in a database as a target managed for a plurality of guest domains in a shared manner.

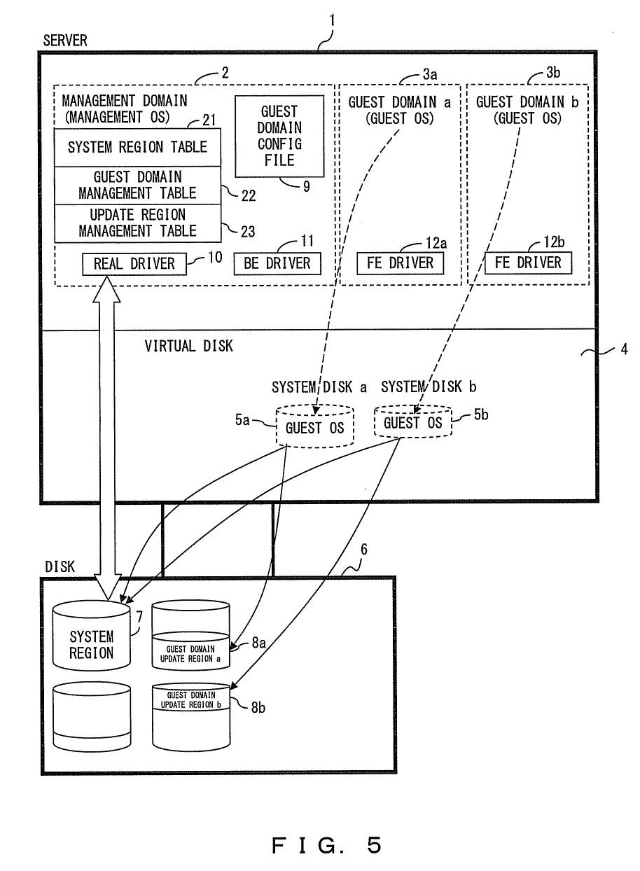

A configuration of a virtual computer system according to an embodiment of the invention is depicted in FIG. 5.

A server 1 that provides a virtual computer system environment includes a management domain 2 and guest domains 3. Each of the guest domains 3 operates using a system disk 5 of a virtual disk 4. Each system disk 5 has a system region 7 and an update region 8 for each guest domain on a disk 6 that is the real disk resources of the server 1.

In the system region 7, a system portion of an operating system (OS) managed by the system in a shared manner, and a fundamental portion of software are stored. Note that the OS of the same type is not redundantly stored in the system region 7. Namely, for example, when guest domains a and b use the same OS, they reference and use the same portion of the system region 7. Since there is no need to secure disk resources for fully installing an OS for each guest domain as described above, the disk resources can be saved. Moreover, if the OS already installed in the system is used when a new guest domain is set, its installation operations can be omitted, leading to an increase in operating efficiency.

Each update region 8 is a region for storing written data when a write access is made from a guest domain 3 to a shared portion of the system, such as an OS system portion, etc. Each update region 8 is prepared for each guest domain. For example, if the guest domain 3 makes a write to the system region 7, which is shared by the entire system, when the guest domain 3 stores data such as individual settings, etc., this write operation exerts an influence on the entire system. Therefore, the data is stored in the update region 8 of each guest domain. At the activation of the guest domain 3, the OS in the system region 7 and the data saved in the update region 8 are merged and passed to the guest domain 3.

To provide the above described virtual computer environment, the management domain 2 has a system region management table 21, a guest domain management table 22, and an update region management table 23.

The system region management table 21 manages an OS stored in the system region 7, and controls a write access to the system region 7.

The guest domain management table 22 manages an OS used by each guest domain 3, and the position of the update region of the guest domain 3.

The update region management table 23 manages the position of the system region 7, to which a write access is made, the position of a guest domain update region, to which data is written, and the size of the data.

Each FE driver 12 controls an I/O access from a corresponding guest domain 3.

A BE driver 11 pairs up with an FE driver 12 to control an I/O access from a guest domain 3. At this time, the BE driver 11 conveys the access position of the disk 6, and the like to a real driver 10 by referencing the system region management table 21, the guest domain management table 22, and the update region management table 23. Moreover, the BE driver 11 merges data transferred from the real driver 10, and transfers the merged data to the guest domain 3.

The real driver 10 controls an I/O access to/from a device such as the disk 6, etc.

First to fourth embodiments are explained below based on the configuration depicted in FIG. 5.

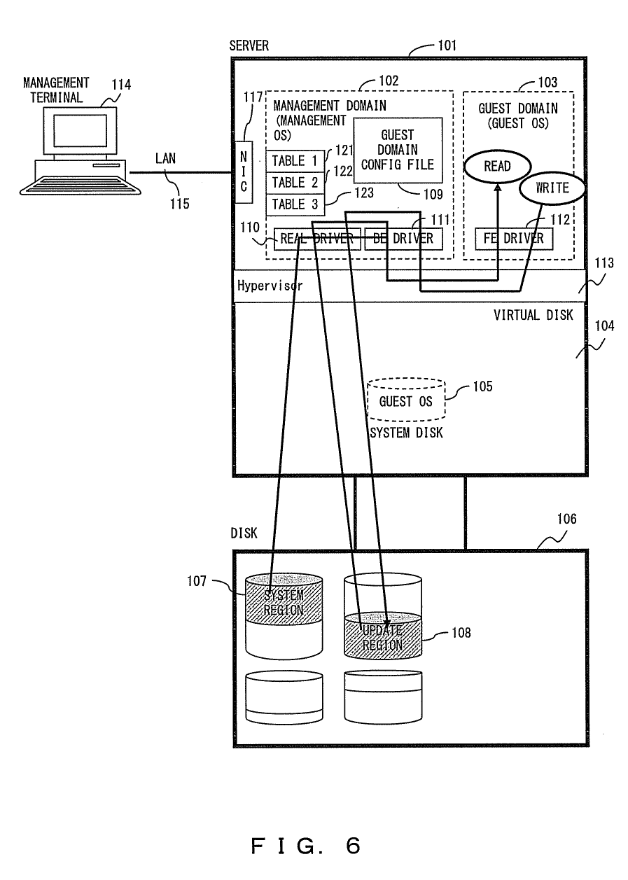

The first embodiment is initially described with reference to FIGS. 6 to 12.

A system configuration of the first embodiment is depicted in FIG. 6.

The system includes a server 101 and a management terminal 114. The server 101 is configured with an information processing device composed of a processor (CPU), a memory, storage resources for storing a program, etc., and an I/O (input/output) interface. The server 101 is connected to the management terminal 114 via an NIC (Network Interface Card) 117, and a communications line of a LAN (Local Area Network) 115, or the like.

On the server 101, a plurality of guest domains 103 that are virtual computers can simultaneously run. A guest OS may vary depending on each of the guest domains 103. The management domain 102 includes a config file 109 that is a file for defining the configuration of each guest domain 103, and manages a virtual computer environment.

Hypervisor 113 is a virtual machine monitor for controlling all of virtual machine functions. A system disk 105 on a virtual disk 104 is composed of a system region 107 and an update region 108 of the disk 106 as described with reference to the configuration depicted in FIG. 5. An access made from the guest domain 103 to the system disk 105 is implemented as an access to the real disk 106 by the FE driver 112, the BE driver 111, and a real driver 110.

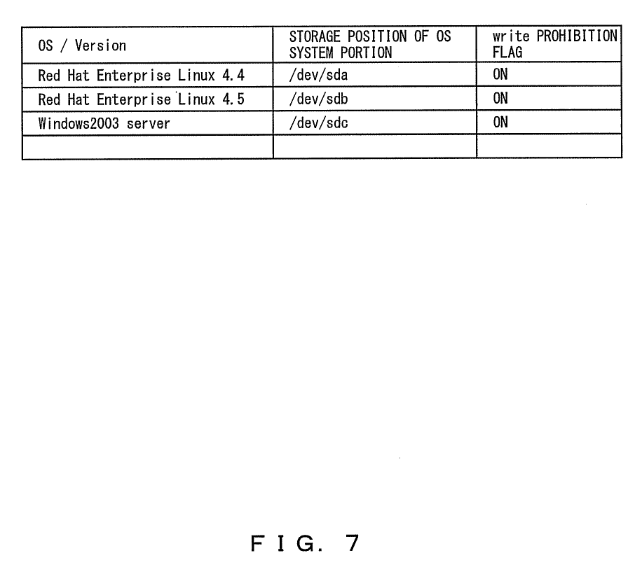

The management domain 102 also has Table 1 (121), Table 2 (122), and Table 3 (123). Further details of the structures of Tables 1 (121) to 3 (123) are described with reference to FIGS. 7 to 9.

Table 1 depicted in FIG. 7 corresponds to the system region management table 21 of FIG. 5, and manages the type of an OS installed in the system. Table 1 includes an entry indicating an OS/version installed in the system, an entry for storing the position information of the system region 107, in which the OS is stored, and an entry for storing a prohibition flag for controlling a write to the region where the OS is stored. For example, the first row of FIG. 7 represents that an OS named Red Hat Enterprise Linux 4.4 is stored in “/dev/sda” of the system region 107, and a write to the OS is prohibited.

When a new OS that is not managed in the system is installed, the management domain 102 registers to Table 1 the type, the storage position, and the write prohibition flag (defaulting to ON) of the installed OS after the OS is installed, and manages these items of information.

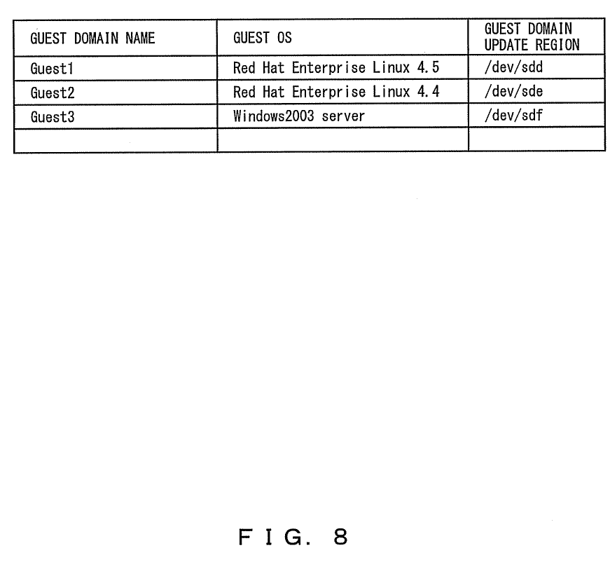

Table 2 depicted in FIG. 8 corresponds to the guest domain management table 22 of FIG. 5, and manages a guest domain 103, an OS used by the guest domain, and the update region of the guest domain. Namely, Table 2 includes a guest domain name, a guest OS, and a guest domain update region. In a guest OS entry, any of OSes managed by Table 1 is stored. In a guest domain update region entry, the position information of the update region 108 is managed. The first row of Table 2 depicted in FIG. 8 represents that a guest domain named “Guest 1” uses an OS named Red Hat Enterprise Linux 4.5, and /dev/sdd is allocated as the update region of the guest domain.

When a new guest domain is set, the management domain 102 records to Table 2 the domain name of the new guest domain, the type of the OS of the guest domain, which is selected from Table 1, and the position information of the allocated update region 108, and manages these items of information.

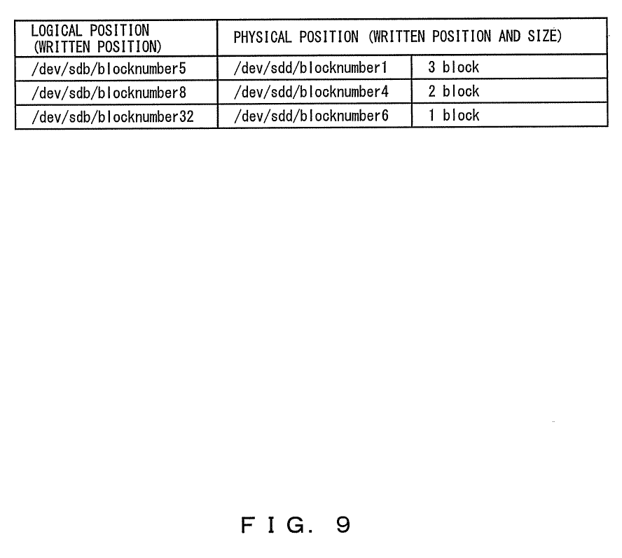

Table 3 depicted in FIG. 9 corresponds to the update region management table 23 of FIG. 5. Table 3 is a table prepared for each guest domain. FIG. 9 depicts the update region management table of, for example, a guest domain named “Guest 1”. Similarly, there are update region management tables of guest domains named “Guest 2” and “Guest 3”, which are not depicted in this figure.

In Table 3 (123), the position of the system region 107, to which a write access is made, and the position of the update region 108, in which data is actually stored, are recorded and managed. When a write access is made to the system region 107, the BE driver 111 conveys the real driver 110 to make a write not to the system region 107 but to the update region 108 of the guest domain. Then, the position of the system region 107, to which the write access is made, is written to a logical position entry of Table 3, and the position of the update region 108, to which data is actually written, and the size of the data are written to a physical position entry of Table 3.

The structures of Table 1 to 3 have been described. When a read access is made from a guest domain 103 to the system region 107, the system operates as follows by referencing Tables 1 to 3. Initially, the BE driver 111 references Table 2 to recognize the guest OS used by the guest domain 103, and obtains the storage position of the OS from Table 1. Then, the BE driver 111 conveys the real driver 110 to read the OS from the obtained storage position. At the same time, the BE driver 111 references Table 3. If data exists in the update region 108, the BE driver 111 conveys the real driver 110 to read the data in the corresponding portion. Then, the BE driver 11 receives the data read by the real driver 110, merges the data, and transfers the merged data to the guest domain 103. For example, when the guest domain 103 named “Guest 1” is activated, the BE driver 111 obtains that Guest 1 uses Red Hat Enterprise Linux 4.5 by referencing Table 2. Then, the BE driver 111 obtains from Table 1 that the OS is stored in /dev/sdb of the system region 107, and the real driver 110 reads the corresponding position. At the same time, data written to the system regions 107 /dev/sdb/blocknumber5, /dev/sdb/blocknumber8, and /dev/sdb/blocknumber32 are proved to exist in /dev/sdd/blocknumber1, /dev/sdd/blocknumber4, and /dev/sdd/blocknumber6 of the update region 108 on the basis of Table 3. Therefore, the real driver 110 also reads the corresponding portions. The BE driver 111 receives the read data, merges the data, and transfers the merged data to the guest domain 103.

The configuration of the first embodiment has been described. Next, processing procedures executed in the case 1 of adding a new guest domain, in the case 2 of activating a guest domain, in the case 3 where a write access is made by a guest domain, in the case 4 of applying a patch to a system region, in the case 5 of applying a patch only to a certain guest domain, and in the case 6 of deleting a guest domain in the first embodiment are described respectively.

1. In the case of adding a new guest domain, the following procedures 1) to 5) are executed in the following order.

1) A user logs in to the management domain 102 with the management terminal 114, and verifies by referencing Table 1 whether or not an OS used as the OS of the guest domain is already installed.

2) When the guest domain using the already installed OS is created, the process goes to procedure 4). Otherwise, the process goes to procedure 3).

3) When an OS that is not installed is used, the OS is installed, namely, the new OS is added to the system region 107. Thereafter, the information of the installed OS is registered to Table 1. At this time, the write prohibition flag is set to ON.

4) The user selects the OS used by the new guest domain from Table 1.

5) The management domain 102 registers to Table 2 information about the name of the guest domain, the OS selected with the procedure 4), and the position of the update region, which is newly allocated to the guest domain, as the information of the new guest domain.

2. In the case of activating a guest domain, the following procedures 1) to 2) are executed in the following order.

1) Initially, the BE driver 111 references Table 2 to recognize the OS of the guest domain to be activated. Moreover, the BE driver 111 recognizes the update region 108 of the guest domain.

2) The BE driver 111 causes the real driver 110 to read the OS of the guest domain 103 from the system region 107, also causes the real driver 110 to read data such as update information, etc. from the update region 108 of the guest domain, and receives the read data. The BE driver 111 then merges the received data, and transfers the merged data to the guest domain 103.

3. In the case where a guest domain makes a write access to the system region, the following procedures 1) to 2) are executed in the following order.

1) When the guest domain 103 makes a write access to the system region 107, the BE driver 111 references Table 1 to verify the write prohibition flag of the corresponding OS. If the write prohibition flag is ON, the BE driver 111 performs a control such that a write is made to the update region 108 of the guest domain 103.

2) Upon completion of the data write, the BE driver 111 writes the position of the system region 108, to which the write access is made, to the logical position entry in Table 3, and writes the position of the update region 108, to which the data is actually written, to the physical position entry in Table 3.

4. In the case of applying a patch to the system region, the following procedures 1) to 4) are executed in the following order.

1) A user logs in to the management domain 102 with the management terminal 114, and changes the write prohibition flag of the OS, to which the patch is to be applied, in Table 1 to OFF.

2) The user activates the guest domain 103 using the OS, to which the patch is to be applied, with the management terminal 114, and applies the patch to the guest domain 103.

3) A write access is made to the system region 107 as a result of applying the patch. The BE driver 111 references Table 1, and determines that the write prohibition flag is OFF. Therefore, the BE driver 111 performs a control such that the write is made to the system region 107.

4) Upon completion of applying the patch, the user logs in to the management domain 102 with the management terminal 114, and resets the write prohibition flag, which is changed with the procedure 1), in Table 1 to ON.

If an operation for applying a patch after activating one guest domain 103 using an OS to which the patch is applied is performed, there is no need to perform this operation after activating another guest domain using the same OS. This is because the system region 108 is the shared portion of the system.

5. In the case of applying a patch only to a certain guest domain, the following procedures 1) to 2) are executed.

1) A user logs in to the management domain 102 with the management terminal 114, activates the guest domain 103 to which the patch is to be applied, and applies the patch to the guest domain 103.

2) A write access is made to the system region 107 as a result of applying the patch. The BE driver 111 references Table 1, and determines that the write flag is ON. Therefore, the BE driver 111 performs a control such that the data of the patch is stored in the update region 108.

When the guest domain 103 to which the patch is applied is activated, data of the system region 108 and that of the update region 108 are merged and transferred to the guest domain 103. Therefore, the OS to which the patch is applied is passed to the guest domain 103.

6. In the case of deleting a guest domain, the following procedures 1) to 3) are executed in the following order.

1) A user logs in to the management domain 102 with the management terminal 114, and deletes the row of the guest domain 103 to be deleted in Table 2.

2) The management domain 102 frees up the update region 108 of the deleted guest domain 103.

3) Thereafter, the management domain 102 deletes Table 3 of the deleted guest domain 103.

The processing procedures executed in the first embodiment have been described. Flows of operations of the system, which are performed in the case of adding a new guest domain, in the case of activating a guest domain, and in the case where a guest domain makes a write access to the system region, are described next.

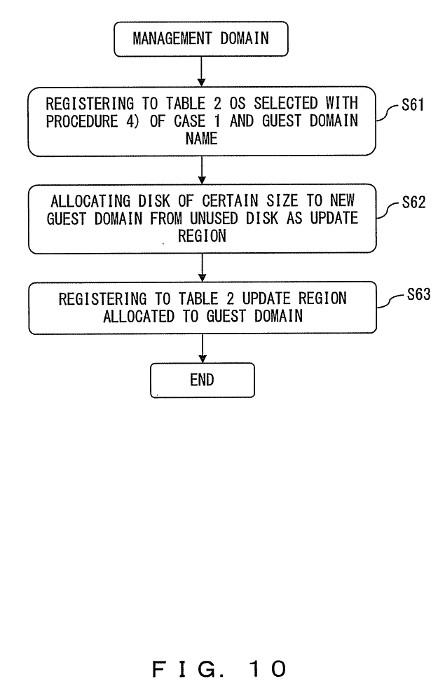

The flow of the management domain in the case of adding a new guest domain is depicted in FIG. 10.

In the case of adding a new guest domain, the management domain 102 registers to Table 2 the OS selected with the above described procedure 4) executed in the case 1 of adding a new guest domain, and the name of the guest domain in S61.

In step S62, a disk of a certain size is allocated from an unused disk to the new guest domain 103 as an update region 108.

Then, the update region 108 allocated to the guest domain 103 is registered to Table 2 (122) in S63.

As a result, information about the added guest domain 103 is added to Table 2 (122).

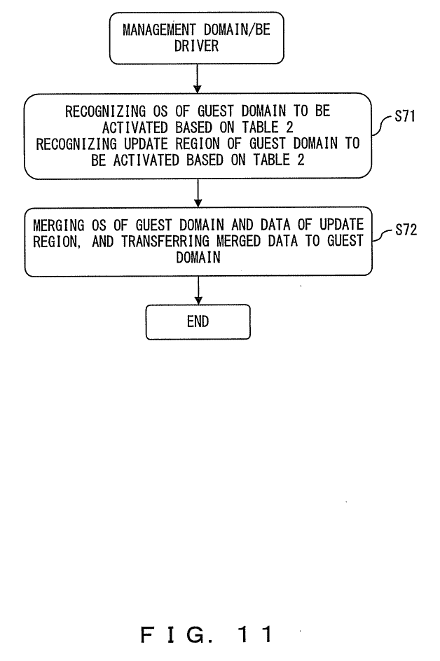

The flow of the BE driver 111 of the management domain 102 in the case of activating a guest domain 103 is depicted in FIG. 11.

When the guest domain 103 is activated, the BE driver 111 recognizes the OS and the update region 108 of the guest domain 103 to be activated based on Table 2 in S71.

Next, in S72, the BE driver 111 merges the OS of the guest domain 103 and the data of the update region 108, and transfers the merged data to the guest domain 103.

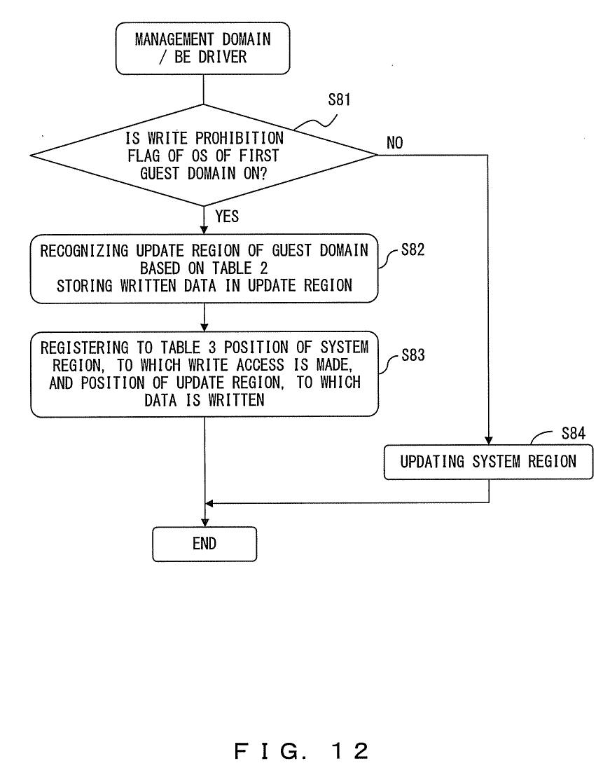

The flow of the BE driver 111 of the management domain 102 in the case where a guest domain makes a write access to the system region 107 is depicted in FIG. 12.

Initially, in S81, whether or not the write prohibition flag of the OS of the guest domain 103 is ON is verified based on Table 1 (121). If the write prohibition flag is OFF, the flow goes to S84. If the write prohibition flag is ON, the flow goes to S82, in which the update region 108 of the guest domain 103 is recognized based on Table 2 (122), and the written data is stored in the update region 108. Then, in S83, the position to which the write access is made, the position of the update region 108, to which the data is written, and the size of the data are registered.

If the flow goes from S81 to S84, the system region 107 is updated by writing the data to the system region 107, and the process is terminated.

The configuration and the operations of the first embodiment have been described in detail.

According to the first embodiment, the system manages an OS in a shared manner, whereby the disk resources can be saved without securing a disk region for each guest domain. Additionally, when a new guest domain is set, an installation operation performed by a user can be omitted if an OS used for the system is already installed. Furthermore, when a write access is made from a guest domain to the system region, data is written to the update region of the guest domain, data is also read from the update region when the system region is read, the read data is merged with the system region, and the merged data can be passed to the guest domain. In this way, the environment of each guest domain can be provided. Moreover, with the operation for applying a patch to an OS, the patch is applied to a shared system region by applying the patch after activating one guest domain among a plurality of guest domains using the target OS. This eliminates the need for activating each guest domain and for applying the patch.

As described above, according to the first embodiment, the disk resources of the system can be saved, and the setting operations of guest domains can be eased and made more efficient.

The second to the fourth embodiments are described next as modification examples of the first embodiment.

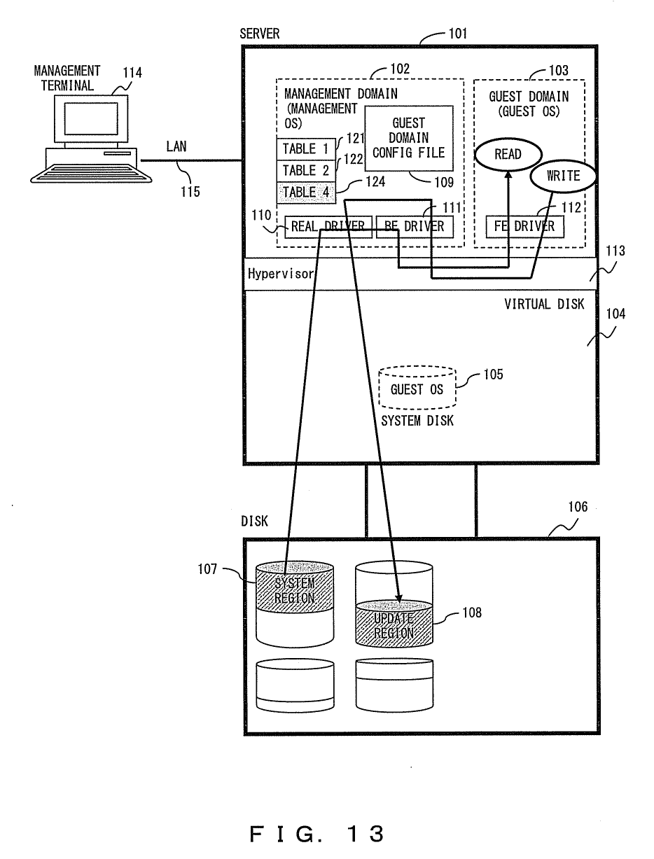

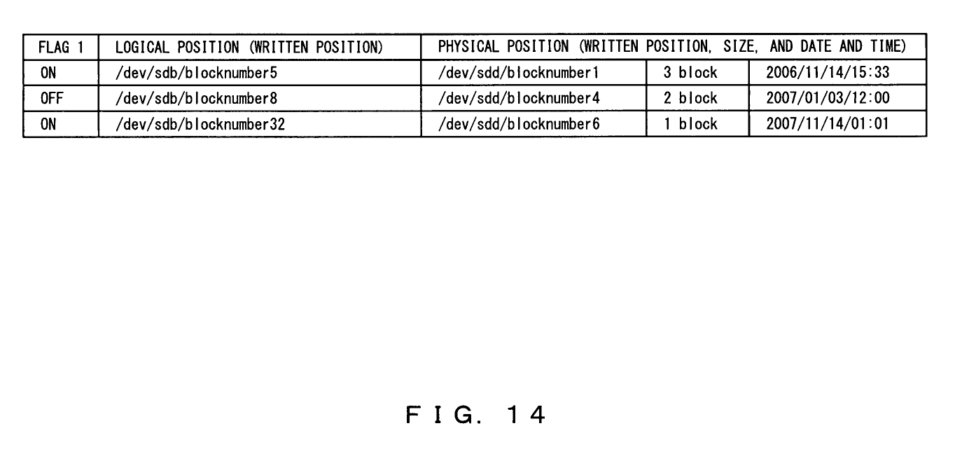

The second embodiment is described first. The configuration of the second embodiment is depicted in FIG. 13. The second embodiment is characterized in that Table 3 (123) is replaced with Table 4 (124) as a table comprised by the management domain 102. The structure of Table 4 is depicted in FIG. 14.

Table 4 further includes an entry of a flag 1, and an entry for storing date and time when a guest domain makes a write access to the update region of the guest domain as history information in addition to the structure of Table 3.

The flag 1 specifies whether or not to merge data stored in a corresponding update region 108 when the system region 107 is read, and to transfer the merged data to the guest domain 103. For example, the flag 1 in the first row is ON in FIG. 14. When /dev/sdb/blocknumber5 in the system region 107 is read in this case, data of three blocks from /dev/sdd/blocknumber1 in the update region 108 are merged and transferred to the guest domain 103 by the BE driver 111. In the meantime, in the second row of FIG. 14, the flag 1 is OFF. In this case, no data is merged even if dev/sdb/blocknumber8 in the system region 107 is read, and the read data is transferred to the guest domain 103 unchanged.

Additionally, the history information is intended to record date and time when data is written to an update region 108.

In the first embodiment, data stored in the system region 107 and the update region 108 are merged and transferred to the guest domain 103. However, in the second embodiment, the structure of Table 4 (124) depicted in FIG. 14 enables a control such that data is transferred to the guest domain 103 without being merged depending on the data of the update region 108. As a result, for example, the OS of a guest domain 103 can be activated after removing a patch, which becomes old, by referencing history information although the settings are originally made so that the patch is stored in an update region 108 and merged with the OS of the system region 107, and the merged OS is transferred to the guest domain 103. In this way, the selection of whether or not to apply a patch can be easily set. Moreover, since the history information is managed, a determination made at the time of selecting data of a patch, etc. can be made with ease.

In the system depicted in FIG. 13, procedures executed in the case 1 of selecting an update region merged with the system region, and in the case 2 of activating a guest domain are as follows.

1. In the case of selecting an update region merged with the system region, the following procedure 1) is executed.

1) A user logs in to the management domain 102 with the management terminal 114, and selects data to be merged with the system region 107 in Table 4 (124). If the data is merged, the flag is set to ON. If the data is not merged, the flag is set to OFF.

2. The following procedures are executed in the case of activating a guest domain.

1) The BE driver 111 initially references Table 2 to recognize the OS of the guest domain to be activated. The BE driver 111 also recognizes the update region 108 of the guest domain.

2) The BE driver 111 causes the real driver 110 to read the OS of the guest domain 103 from the system region 107, and also causes the real driver 110 to read data such as update information, etc. from the update region 108 of the guest domain specified to be merged by referencing Table 4, and receives the read data. The BE driver 111 merges the received data, and transfers the merged data to the guest domain 103.

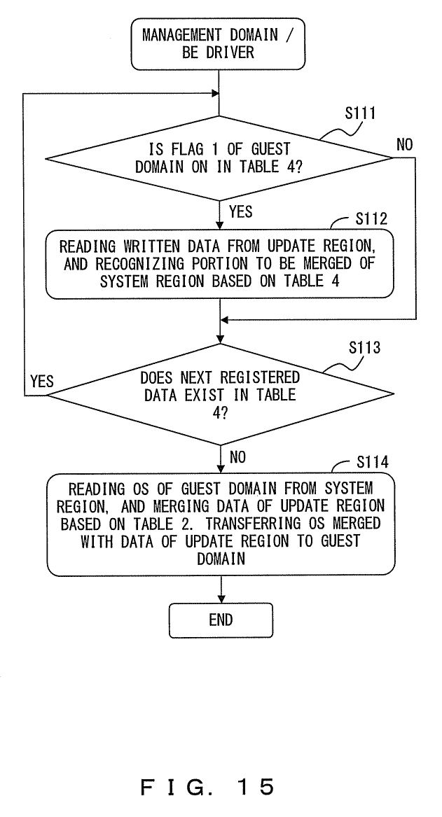

Operations of the BE driver 111 in the management domain 102 in the case of activating a guest domain 103 in the configuration of the second embodiment are described with reference to FIG. 15.

Initially, in S111, whether or not the flag 1 of the guest domain in Table 4 is ON is verified. If the flag 1 is OFF (NO), the flow goes to S113.

If the flag 1 is ON in S111 (YES), the flow goes to S112, in which written data is read from the update region 108, and the portion to be merged of the system region 108 is recognized based on Table 4. In S113, whether or not the next registered data exists is determined in Table 4. If the next registered data exists in Table 4 (YES), the flow goes back to S111. If the next registered data does not exist in Table 4 (NO), the flow goes to S114, in which the OS of the guest domain 103 is read from the system region 107 on the basis of Table 2, and the data of the update region 108 is merged. The merged OS is then transferred to the guest domain 103.

The configuration and the operations of the second embodiment have been described.

According to the second embodiment, a selection of whether or not to apply a patch can be easily set, whereby the operating efficiency of a user can be increased. Moreover, the newness of data of the update region 108 can be immediately determined by managing history information.

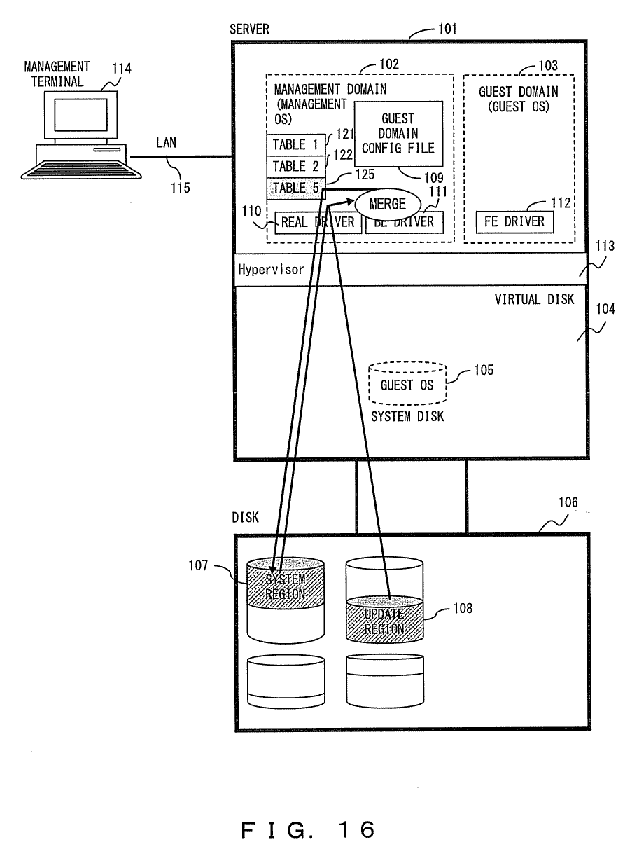

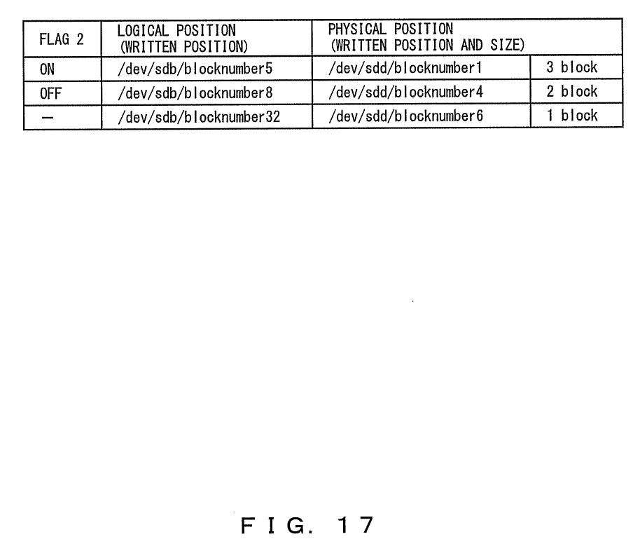

The third embodiment is described next. A configuration of the third embodiment is depicted in FIG. 16. The third embodiment is characterized in that Table 3 (123) of the first embodiment is replaced with Table 5 (125) as a table comprised by the management domain 102. The structure of Table 5 is depicted in FIG. 17.

Table 5 further has an entry for storing a flag 2 in addition to the configuration of Table 3.

The flag 2 is intended to select and specify data of an update region 108 in order to again store merged data of the system region 107 and the update region 108 in the system region 107.

For example, in FIG. 17, the flag 2 in the first row is ON. When the management domain 102 instructs the process for merging the system region 107 and the update region 108, three blocks are read from the update region 108 /dev/sdd/blocknumber1, and merged with the system region 107 /deb/sdb/blocknumber5, and the merged data is stored in the system region 107. Since the flag 2 of data managed in the second row of FIG. 17 is OFF, it is not merged. Upon completion of the merging process, the management domain 102 rewrites the flag 2 of the data merged with the system region 107 to “-”. As a result, the data in the corresponding portion of the update region 108 is invalidated, and not read at the time of activation, etc.

The structure of Table 5 (125) in the third embodiment enables a patch to be easily applied to a shared portion of the system if a stable operation is verified to be performed after the patch is stored in the update region 108 of a guest domain 103 and the trial use of the OS is made for a while. The structure of Table 5 (125) also enables data such as settings individually used by a guest domain 103 to be easily reflected on a shared portion of the system.

In the system depicted in FIG. 16, procedures executed in the case 1 of selecting data of an update region to be merged with the system region, and in the case 2 of merging data of an update region with the system region are as follows.

1. In the case of selecting the data of the update region to be merged with the system region, the following procedure 1) is executed.

1) A user logs in to the management domain 102 with the management terminal 114, and selects the data of the update region 108 to be merged with the system region 107 in Table 5 (125). If the data is merged, the flag 2 is set to ON. If the data is not merged, the flag 2 is set to OFF.

2. The following procedures 1) to 3) are executed in the case of merging the data of an update region with the system region.

1) A user instructs the management domain 102 to execute a process for merging the data of the update region 108 with the management terminal 114.

2) The BE driver 111 controls the real driver 110 to read data in the logical position of the system region 108 the flag of which is ON, and the data of the update region 108 by referencing Table 5. Then, the BE driver 111 receives the data read by the real driver 110, merges the data in the logical position of the system region 108 and that in the physical position of the update region 108, and rewrites the merged data in the logical position of the system region 107.

3) Upon completion of the rewrite, the BE driver 111 invalidates the flag 2 by setting it to “-”.

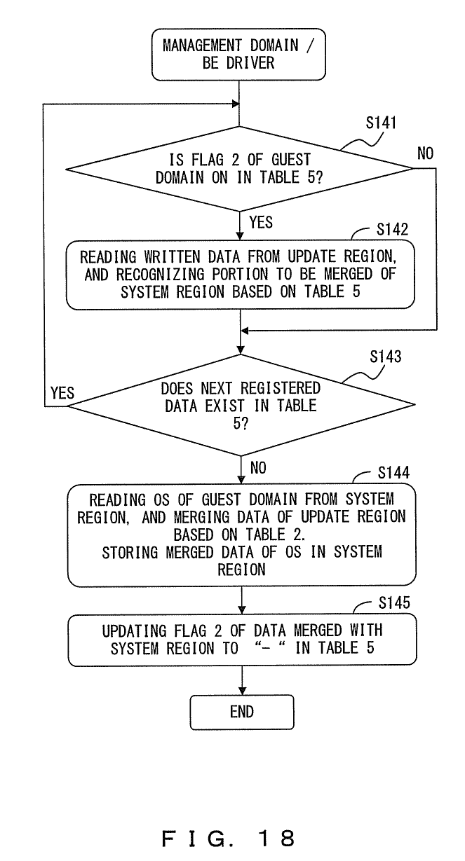

Operations of the BE driver 111 in the management domain 102 in the case of selecting data to be merged with the system region 107 in the configuration of the third embodiment are described next with reference to FIG. 18.

Initially, whether or not the flag 2 of the guest domain in Table 5 is ON is verified in S141. If the flag 2 is OFF (NO), the flow goes to S143. If the flag 2 is ON (YES), the flow goes to S142. In S142, written data is read from the update region 108, and the portion to be merged of the system region 107 is recognized based on Table 5.

In S143, whether or not the next registered data exists in Table 5 is verified. If the next registered data exists (YES), the flow goes back to S141. If the next registered data does not exist (NO), the flow goes to S144.

In S144, the OS of the guest domain is read from the system region 107 on the basis of Table 2, and the data of the update region 108 is merged. The data of the merged OS is stored in the system region 107 of the OS. Then, in S145, the flag 2 of the merged data is invalidated in Table 5 by setting it to “-”.

The configuration and the operations of the third embodiment have been described.

According to the third embodiment, data of an update region 108 of each guest domain can be easily reflected on the system region 107, thereby increasing the operating efficiency of a user.

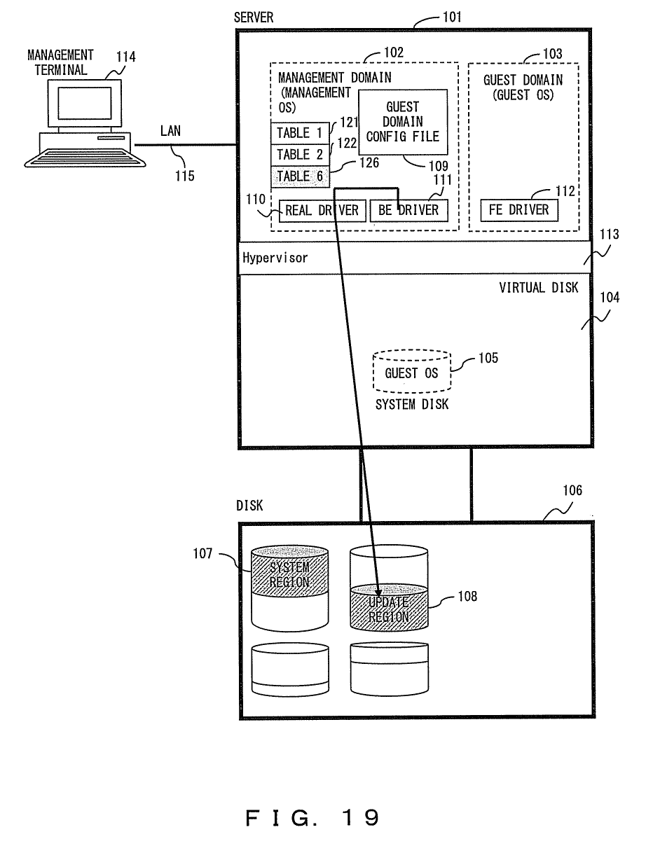

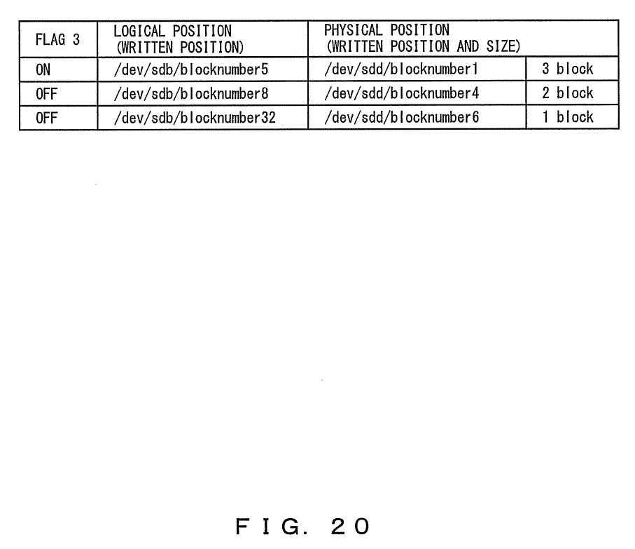

The fourth embodiment is described next. A configuration of the fourth embodiment is depicted in FIG. 19. The fourth embodiment is characterized in that Table 3 (123) in the first embodiment is replaced with Table 6 (126) as a table comprised by the management domain 102. The structure of Table 6 is depicted in FIG. 20.

Table 6 further has an entry for storing a flag 3 in addition to the structure of Table 3.

The flag 3 is intended to specify a deletion of data in an update region 108.

For example, in FIG. 20, the flag 3 in the first row is ON. When the management domain 102 instructs a process for deleting the data of the update region, three blocks are deleted from the update region 108 /dev/sdd/blocknumber1. In FIG. 20, the flag 3 in the second and the third rows is OFF. Therefore, data is not deleted. In this way, for example, the data invalidated in the third embodiment can be deleted from the update region 108, whereby the disk resources can be saved.

In the system depicted in FIG. 19, procedures executed in the case 1 of selecting data of an update region to be deleted, and the case 2 of deleting data of an update region are as follows.

1. The following procedure 1) is executed in the case of selecting data of an update region to be deleted.

1) A user logs in to the management domain 102 with the management terminal 114, and selects the data of the update region 108 to be deleted in Table 6. The flag 3 of the data to be deleted is set to ON, whereas the flag 3 of data not to be deleted is set to OFF.

2. The following procedures 1) to 3) are executed in the case of deleting data of an update region.

1) A user instructs the management domain 102 to delete the data of the update region 108 with the management terminal 114.

2) The BE driver 111 of the management domain 102 references Table 6, and controls the real driver 110 to delete the data specified to be deleted from the update region 108.

3) Upon completion of the deletion process, the BE driver 111 of the management domain 102 deletes the information of the deleted data in Table 6.

The configuration and the processing procedures of the fourth embodiment have been described.

According to the fourth embodiment, the data of an update region 108 that becomes unnecessary in each guest domain can be deleted, whereby the use efficiency of the disk resources can be increased.

The first to the fourth embodiments have been described up to this point. The second to the fourth embodiments are characterized in that the structure of Table 3 in the first embodiment is modified. However, these structures may be collectively implemented as the structure of one table as a matter of course.

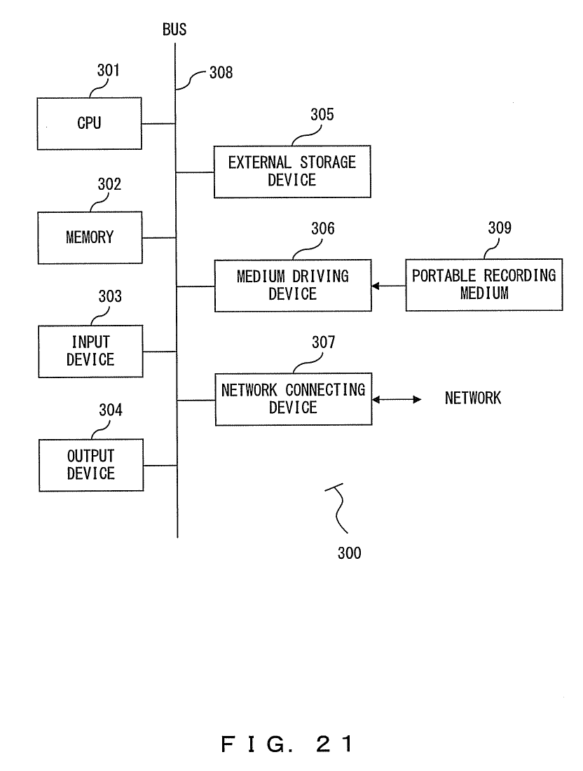

The embodiments according to the present invention have been described with reference to the drawings. A hardware configuration of an information processing device 300 for implementing the above described virtual computer system is depicted in FIG. 21.

The information processing device 300 has a configuration where a CPU 301, a memory 302, an input device 303, an output device 304, an external recording device 305, a medium driving device 306, a portable recording medium 309, and a network connecting device 307 are interconnected by a bus 308.

The memory 302 includes, for example, a ROM (Read Only Memory), a RAM (Random Access Memory), etc., and stores a program and data for implementing a management domain, guest domains, respective drivers, etc.

The CPU 301 implements the virtual computer system by executing the program with the memory 302.

The input device 303 is, for example, a keyboard, a pointing device, a touch panel, etc., and used to input information, etc. The output device 304 is, for example, a display, a printer, etc.

The external storage device 305 is, for example, a magnetic disk device, an optical disk device, a magneto-optical disk device, etc. The program and the data are stored in the external storage device 305, and can be loaded into the memory 302 and used as needed.

The medium driving device 306 drives the portable recording medium 309, and accesses its recorded contents. As the portable recording medium 309, an arbitrary computer-readable recording medium such as a memory card, a memory stick, a flexible disk, a CD-ROM (Compact Disc-Read Only Memory), an optical disk, a magneto-optical disk, a DVD (Digital Versatile Disk), etc. is used. The program and the data are stored on the portable recording medium 309, and can be loaded into the memory 302 and used as needed.

The network connecting device 307 communicates with an external device via an arbitrary network (line) of a LAN, a WAN, etc., and performs data conversion accompanying a communication. Moreover, the network connecting device may receive from an external device the program and the data, which can be loaded into the memory 302 and used as needed.

The program running on the information processing device 300 is configured to execute the processes (the flows depicted in FIGS. 10, 11, 12, 15, and 18) of the above described management domain, guest domains and respective drivers by using the memory 302, etc. of the information processing device 300.

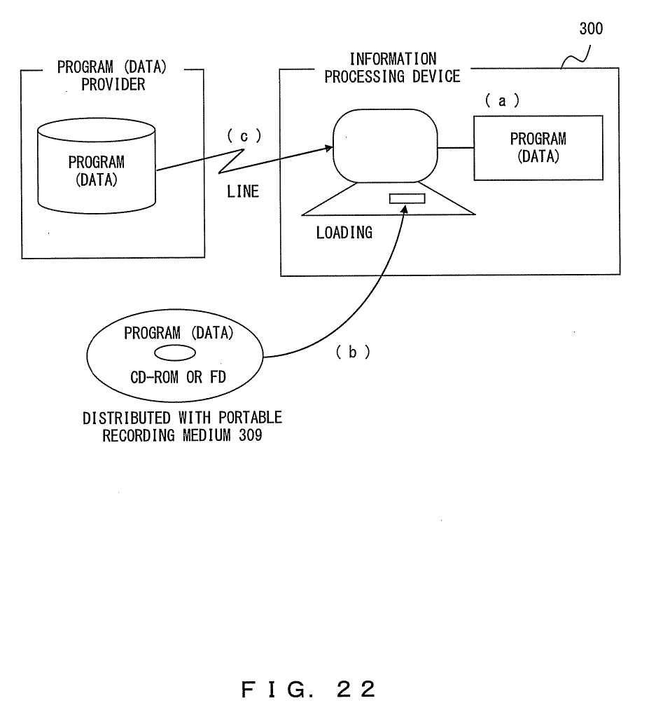

A method for loading a program into the information processing device when the virtual computer system according to the present invention is implemented in a way such that the information processing device 300 executes the program is depicted in FIG. 22.

(a) of FIG. 22 represents a method by which the information processing device 300 loads a program and data, which are stored in the external storage device 305 such as a hard disk, etc., of the information processing device 300.

(b) of FIG. 22 represents a method for loading a program and data, which are recorded on a portable recording medium such as a CD-ROM, a DVD, etc., via the medium driving device of the information processing device 300.

(c) of FIG. 22 represents a method for loading a program and data, which are provided by an information provider, via a line of a network, etc. through a communications device of the information processing device 300.

As described above, the embodiments according to the present invention may be configured as a program for causing the information processing device to execute the functions of the above described virtual computer system. Additionally, the embodiments according to the present invention may be a computer-readable recording medium on which is recorded a program for causing the information processing device to execute the functions of the above described virtual computer system. Furthermore, the embodiments according to the present invention may be configured as a computer data signal representing the above described program embodied on a carrier wave.

The present invention is not limited to the above described embodiments, and can take diverse configurations or forms within a scope that does not depart from the gist of the present invention.

All examples and conditional language recited herein are intended for pedagogical purposes to aid the reader in understanding the invention and the concepts contributed by the inventor to furthering the art, and are to be constructed as being without limitation to such specifically recited examples and condition, nor does the organization of such examples in the specification relate to a showing of the superiority and inferiority of the invention. Although the embodiments of the inventions have been described in detail, it should be understood that the various changes, substitutions, and alterations could be made hereto without departing from the spirit and scope of the invention.

What is claimed is:

1. A virtual computer system where a plurality of guest domains run on one information processing device, comprising:
a system region for storing software, which is installed for the plurality of guest domains, to be managed by the virtual computer system in a shared manner; and
an update region for actually storing data when each of the plurality of guest domains makes a write access to the system region.

2. The virtual computer system according to claim 1, wherein the software is an operating system.

3. An information processing device which provides a virtual computer system where a plurality of guest domains run, and includes a system region for storing a portion of software installed for the plurality of guest domains which is managed by the virtual computer system in a shared manner, and an update region for storing data when each of the plurality of guest domains makes a write access to the system region, within disk resources of the information processing device, the information processing device comprising:
system region management means for managing software stored in the system region, and for controlling a write access to the system region;
guest domain management means for managing the software used by the plurality of guest domains, and the update region used by each of the plurality of guest domains; and
write information management means for managing a correspondence between a logical position of the system region to which a write access is made, and a physical position of an update region to which actual data is written, when any of the plurality of guest domains makes a write access to the system region.

4. The information processing device according to claim 3, wherein:
the system region management means includes a table that manages a name of software stored in the system region, and a write prohibition flag for controlling a write to a region where the software is stored; and
a write access control is performed so that a write is prohibited by setting a corresponding write prohibition flag to ON immediately after the software is installed, and a write is permitted by setting the write prohibition flag to OFF if necessary information is reflected on the system region.

5. The information processing device according to claim 3, further comprising
means for reading data of a system region in which the software used by the plurality of guest domains is stored, by referencing the guest domain management means, for reading data stored in the update region when the guest domain makes a write access to the system region by referencing the write information management means, for merging the data read from the system region and the data read from the update region, and for passing the merged data to the guest domain when the guest domain uses the software.

6. The information processing device according to claim 3, wherein
the write information management means further manages, as history information, a date and time when the guest domain makes the write access to the system region.

7. The information processing device according to claim 3, wherein
the write information management means further has a flag for selecting and specifying whether or not to merge data of the update region with the system region and to pass the merged data, when the guest domain uses the software.

8. The information processing device according to claim 3, wherein
the write information management means further has a flag for selecting and specifying data of the update region, which is to be merged with the system region and again stored in the system region.

9. The information processing device according to claim 3, wherein
the write information management means further has a flag for selecting and specifying data to be deleted from the update region.

10. The information processing device according to claim 3, wherein
the software is an operating system.

11. An information storing method for disk resources of an information processing device providing a virtual computer system where a plurality of guest domains run, the method comprising:
storing software which is installed for the plurality of guest domains, in a system region of the disk resources which is managed by the virtual computer system in a shared manner; and
storing written data in an update region of each of the plurality of guest domains, when any of the plurality of guest domains makes a write access to the system region.

12. A computer-readable medium that stores a program executed by an information processing device providing a virtual computer system where a plurality of guest domains run, the program comprising:
a step of storing software which is installed for the plurality of guest domains, in a system region of disk resources which is managed by the virtual computer system in a shared manner; and
a step of storing written data in an update region of each of the plurality of guest domains, when any of the plurality of guest domains make makes a write access to the system region.

13. The computer-readable medium according to claim 12, wherein the program further comprising
a step of merging data of the system region and data of the update region by referencing a guest domain table that manages software and an update region, which are used by each of the guest domains, a write information management table that manages a correspondence between a logical position of the system region, to which each of the plurality of guest domains makes a write access, and a physical position of the update region, to which data is actually written, and of passing the merged data to the guest domain, when the guest domain uses the software.

14. The computer-readable medium according to claim 12, wherein the program further comprising
a step of writing data to the system region if a write to the system region is permitted, and writing data to the update region if a write is prohibited by referencing a system region management table composed of a name of software stored in the system region, and a flag for controlling a write access to the system region, when the guest domain makes a write access to the system region.
